(19) United States
(12) Patent Application Publication
(10) Pub. No.: US 2011/0029991 A1
(43) Pub. Date: Feb. 3, 2011

(54) Electronic media organizer

(76) Inventor: Leigh Kuykendal, Des Plaines, IL (US)

Correspondence Address: LAW OFFICE OF KYLE FLETCHER, P.O. Box 11735, CHARLOTTE, NC, 28220, US

(21) Appl. No.: 12/512,119

(22) Filed: Jul. 30, 2009

(51) Int. Cl. G11B 17/02

(52) U.S. Cl. 720/600

(57) ABSTRACT

The electronic media organizer includes a plurality of storage bins that organize discs according to the type of application, and further categorizes each type of application by type of movie, music, game, etc.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to the field of media organizers, more specifically, an electronic storage device that scans and organizes for CDs, DVDs, Video Games, or Data Discs.

B. Discussion of the Prior Art

As a preliminary note, it should be stated that there is an ample amount of prior art that deals with storage devices. As will be discussed immediately below, no prior art discloses an electronic storage device that scans, categorizes, and stores a plurality of discs associated for use with CDs, DVDs, Video Games, or Data Discs.

The Kusunoki Patent (U.S. Pat. No. 6,370,444) discloses a disc library that has shelves for storing discs and a drive for reading the data on the disks. However, the disc library is not a compact unit that fits within a home entertainment system, and is designed to organize the types of media involved with a home entertainment system.

The Taylor Patent (U.S. Pat. No. 5,907,532) discloses a data disc handling, storage, and retrieval apparatus. However, the apparatus is not capable of organizing discs into categories involving movies, music, games, or software applications.

The Elbaum Patent Application Publication (U.S. Pub No. 2006/0187771) discloses a CD storage device. However, the device is only directed to storing CDs as opposed to categorizing discs for various uses and further categorizing each use by types of music, games, movies, etc.

The Smith II, et al. Patent (U.S. Pat. No. 5,884,298) discloses a method of cataloging optical disks by reading the data on the disks and then storing the disks. However, the method and storage device is not suited for use in an entertainment center wherein varying discs are scanned, categorized by use, then further categorized for each use by types of music, games, movies, etc.

The Debiez Patent (U.S. Pat. No. 6,563,771) discloses an apparatus and system for handling and storing a plurality of data storage discs.

While the above-described devices fulfill their respective and particular objects and requirements, they do not describe an electronic media organizer that. In this regard, the electronic media organizer departs from the conventional concepts and designs of the prior art.

### SUMMARY OF THE INVENTION

The electronic media organizer includes a plurality of storage bins that organize discs according to the type of application, and further categorizes each type of application by type of movie, music, game, etc.

It is an object of the invention to provide an electronic media organizer that stores and organizes a plurality of discs according to the type of application involved with each disc.

A further object of the invention is to provide an electronic media organizer that further organizes each type of application by type of music, movie, game, etc.

These together with additional objects, features and advantages of the electronic media organizer will be readily apparent to those of ordinary skill in the art upon reading the following detailed description of presently preferred, but nonetheless illustrative, embodiments of the electronic media organizer when taken in conjunction with the accompanying drawings.

In this respect, before explaining the current embodiments of the electronic media organizer in detail, it is to be understood that the electronic media organizer is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the electronic media organizer. It is therefore important that the claims be regarded as including such equivalent construction insofar as they do not depart from the spirit and scope of the electronic media organizer. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings

FIG. 1 illustrates an isometric view of the electronic media organizer;

FIG. 2 illustrates a front view of the electronic media organizer detailing the plurality of buttons, LCD screen, and front loader;

FIG. 3 illustrates a top view of the electronic media organizer further detailing plurality of storage bins depicted in hidden lines, and the electronic cord; and

FIG. 4 illustrates a diagram of the various components of the electronic media organizer.

### DETAILED DESCRIPTION OF THE EMBODIMENT

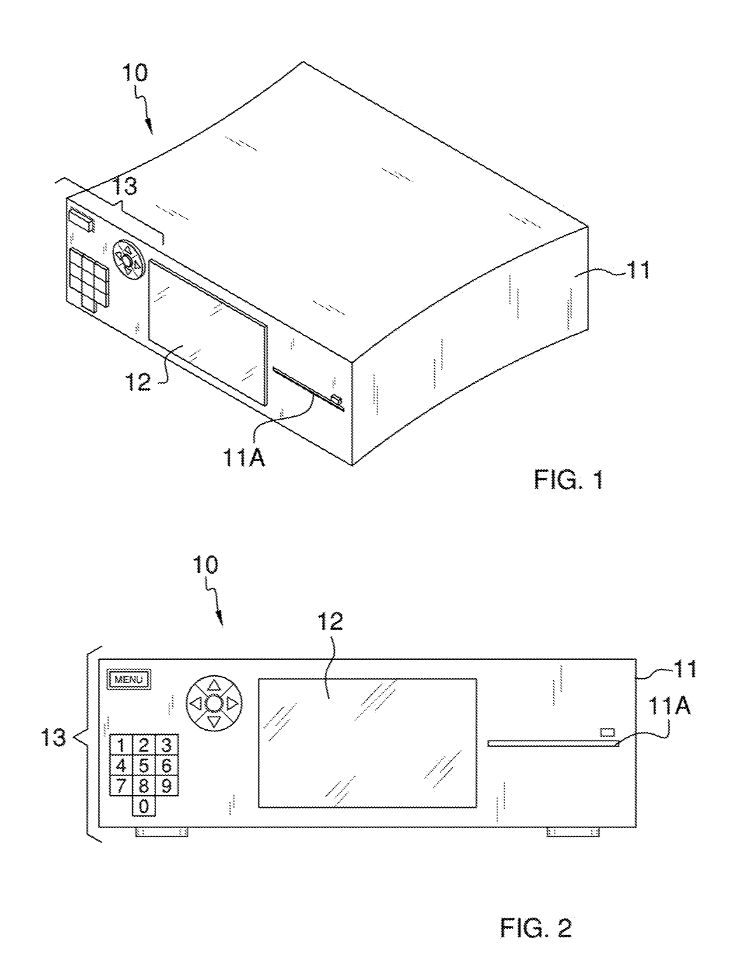

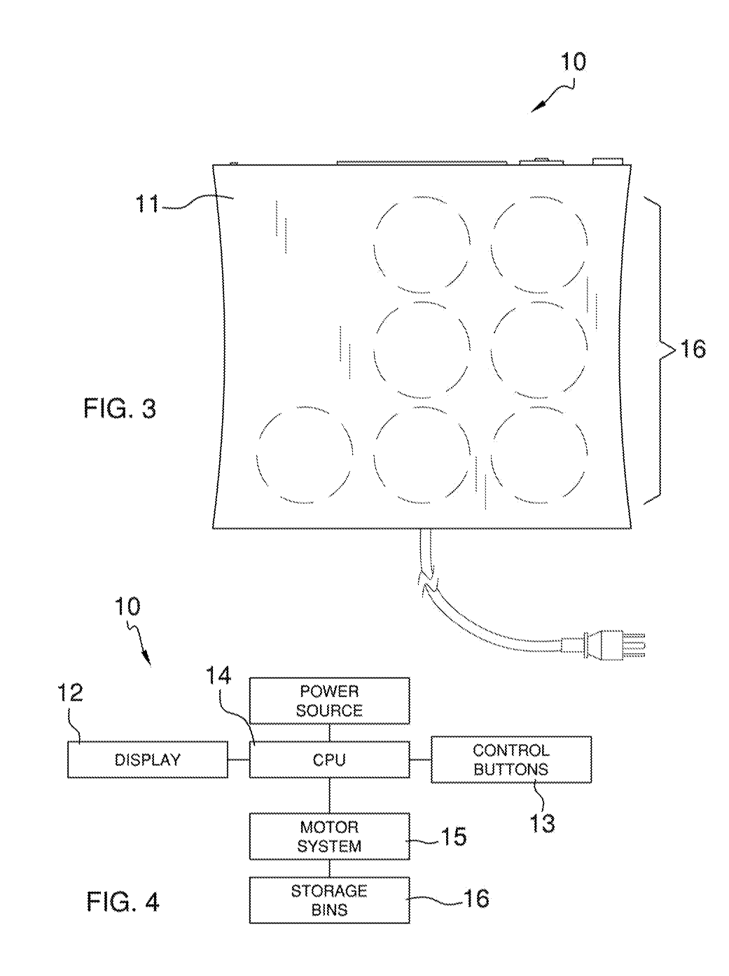

Detailed reference will now be made to the preferred embodiment of the present invention, examples of which are illustrated in FIGS. 1-4. A electronic media organizer 10 (hereinafter invention) includes a housing 11, a display 12, a plurality of controls 13, a microprocessor 14, a motor systems 15, and a plurality of storage bins 16.

The microprocessor 14 is responsible for all aspects of the invention 10, and controls the motor systems 15 in order to remove a compact disc from a front loader 11A.

The microprocessor 11 is also capable of scanning each compact disc in order to determine the type of application of the compact disc as audio, video, audio-visual, gaming, or data storage. The microprocessor 11 further determines what genre of music, movie, game, or data. The microprocessor 11 further displays all of the relevant information on the display 12.

The plurality of controls 13 enable an end user to operate the microprocessor 11 in order to turn the power on or off, to operate the front loader 11A, to scan a compact disc, and other functions attributed with storage of compact discs.

With respect to the above description, it is to be realized that the optimum dimensional relationship for the various components of the invention 10, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention 10.

It shall be noted that those skilled in the art will readily recognize numerous adaptions and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

While the embodiments of the invention have been disclosed, certain modifications may be made by those skilled in the art to modify the invention without departing from the spirit of the invention.

The inventor claims:

1. An electronic media organizer further comprising:
a plurality of storage bins, wherein said storage bins are designed to each store a plurality of compact discs;
a processor capable of scanning and storing said compact discs according to type of application, and further categorizing said compact discs according to type of music, movie, game, or software;
a display and a plurality of control buttons enable a compact disc to be inserted, scanned, stored according to type, and removed from said storage bins.

2. The electronic media organizer as described in claim 1 wherein said display indicates the type of compact disc scanned, and further displays the name of author, the type of application, and other biographical information.

3. The electronic media organizer as described in claim 2 wherein said media organizer is contained within a housing wherein said storage bins are horizontally oriented.

4. The electronic media organizer as described in claim 3 wherein a front loader provides a means of inserting and removing compact discs from the electronic media organizer.
